(19) United States
(12) Patent Application Publication
(10) Pub. No.: US 2026/0251880 A1
(43) Pub. Date: Aug. 27, 2026

(54) OPTICAL IMAGING LENS

(71) Applicant: Genius Electronic Optical (Xiamen) Co., Ltd., Xiamen (CN)

(72) Inventor: Guangwei Fu, Xiamen (CN)

(73) Assignee: Genius Electronic Optical (Xiamen) Co., Ltd., Xiamen (CN)

(21) Appl. No.: 19/201,938

(22) Filed: May 8, 2025

(30) Foreign Application Priority Data
Feb. 21, 2025 (CN) 202510194606.1

(51) Int. Cl. G02B 7/02

(52) U.S. Cl. CPC G02B 7/026; G02B 7/021; G02B 7/025

(57) ABSTRACT

The invention provides an optical imaging lens, which comprises a fixing ring, a barrel and a plurality of lens elements arranged in the barrel. A front end of the barrel includes four circular arc wall parts and four vertical wall parts, which are spaced apart from each other and symmetrically arranged, and each vertical wall part includes a groove structure along an optical axis direction, which includes a bottom surface and two inclined planes, wherein 100 degrees≤θ≤130 degrees and 0.3 mm≤Tsw≤0.6 mm are satisfied. The fixing ring comprise four protruding structures in the optical axis direction, and the protruding structure of the fixing ring and the groove structure of the barrel can complement each other to form an alignment structure.

### BACKGROUND OF THE INVENTION

### 1. Field of the Invention

The invention relates to the optical field, especially to an improved optical lens design structure, wherein a fixing ring has a plurality of protruding structures, and a barrel has a plurality of groove structures, the protruding structures and the groove structures complementing each other to form an alignment structure, the optical imaging lens of the invention having a smaller volume and a larger telephoto magnification.

### 2. Description of the Prior Art

The specifications of portable electronic products are changing with each passing day, and their key component: the optical imaging lens, is also developing in a more diversified manner. The application of the optical imaging lens is not only limited to capturing images and recording videos, but also includes the demand for telephoto imaging. However, the telephoto magnification and focal length of the optical imaging lens are proportional to its size, causing the lens size to increase with the magnification. In addition, the aperture value is inversely proportional to the focal length; when the telephoto magnification increases, it is necessary to increase the entrance pupil diameter of the optical imaging lens, that is, to increase the area perpendicular to the optical axis direction (XY direction) to prevent the aperture value from becoming excessively large. At the same time, because the entrance pupil diameter of the lens is larger, the outer diameter of a first lens is usually larger than that of a second lens or a third lens, so the design of the barrel will differ from that of a general optical imaging lens.

Therefore, how to arrange an optical imaging lens of a larger size within the limited installation space of portable electronic products and provide a design with a yield suitable for mass production is a problem that the invention needs to solve.

### SUMMARY OF THE INVENTION

An optical imaging lens, from a first side to a second side along an optical axis, sequentially includes a fixing ring, a barrel, and a plurality of lens elements arranged in the barrel, wherein the barrel includes a front end close to the first side and a rear end close to the second side, the front end includes a barrel first-side opening, the rear end includes a barrel second-side opening, a maximum inner diameter of the barrel first-side opening is larger than a maximum inner diameter of the barrel second-side opening, the front end of the barrel includes four vertical wall parts and four circular arc wall parts, the circular arc wall parts and the vertical wall parts are spaced apart from each other and symmetrically arranged, each of the vertical wall parts includes a groove structure along an optical axis direction, the groove structure includes a bottom surface and two inclined planes, wherein the conditions of 100 degrees≤θ≤130 degrees, 0.3 mm≤Tsw≤0.6 mm, and 1.0≤Tsw/Dg≤2.0 are satisfied, wherein θ is an angle between the bottom surface and the inclined planes, Tsw is a minimum thickness of the vertical wall part in a radial direction, Dg is the depth of the groove structure in the optical axis direction, the fixing ring includes four protruding structures in the optical axis direction, and the protruding structures of the fixing ring can complement the groove structures of the barrel to form an alignment structure.

The invention is characterized in that, in order to increase the telephoto magnification of the optical imaging lens, it is necessary to increase the entrance pupil diameter of the optical imaging lens. However, since the entrance pupil diameter is proportional to the area of a first lens of the optical imaging lens, it will lead to an increase in the inner diameter and outer diameter dimensions of the lens and cause an increase in the volume of the barrel, which is not conducive to the miniaturization of optical products. Therefore, the invention improves the structure of the optical imaging lens by truncating the outer side surface of the barrel in four different directions, that is, changing the original cylindrical side wall of the barrel into a shape with symmetrically and alternately arranged circular arc wall parts and vertical wall parts. In this way, the total volume of the barrel can be reduced. However, after the above structural change to the barrel, the alignment accuracy requirement between the barrel and the fixing ring also increases, so the invention provides a plurality of groove structures on the barrel and a plurality of corresponding protruding structures on the fixing ring, the groove structures on the barrel and the protruding structures on the fixing ring complementing each other to form an alignment structure. Therefore, the alignment degree between the barrel and the fixing ring can be accurately improved. In addition, the invention also restricts and defines the dimensions of various components on the barrel and the fixing ring. Under the restriction conditions of the invention, an optical imaging lens with high alignment accuracy, high structural strength, and good imaging quality can be produced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an exploded view of the structure of the optical imaging lens of the invention.

FIG. 2 illustrates a top view of the barrel of the optical imaging lens of the invention.

FIG. 3 illustrates a bottom view of the fixing ring of the optical imaging lens of the invention.

FIG. 4 illustrates a top view of the optical imaging lens of the invention.

FIG. 5 illustrates a sectional view taken along the section line A-A′ shown in FIG. 4.

FIG. 6 illustrates a partially enlarged schematic view of the region R1 in FIG. 5.

FIG. 7 illustrates an enlarged schematic view of the region R2 in FIG. 2.

FIG. 8 illustrates a schematic sectional view of the groove structure of the barrel and the protruding structure of the fixing ring.

FIG. 9 illustrates a sectional view taken along the section line B-B′ shown in FIG. 4.

FIG. 10 illustrates a partially enlarged schematic view of the region R3 in FIG. 9.

### DETAILED DESCRIPTION

To provide a better understanding of the invention to those skilled in the technology of the invention, preferred embodiments are detailed as follows. The preferred embodiments of the invention are illustrated in the accompanying drawings with numbered elements to clarify the contents and the effects to be achieved.

For convenience of explanation, the drawings of the invention are only schematic to facilitate understanding of the invention, and their detailed proportions can be adjusted according to design requirements. The up-and-down relationship of the relative components described in the text with respect to the figures should be understood by those skilled in the art as referring to the relative positions of the objects, and thus can be inverted to present the same components, all of which should fall within the scope disclosed by this specification, which is hereby stated in advance.

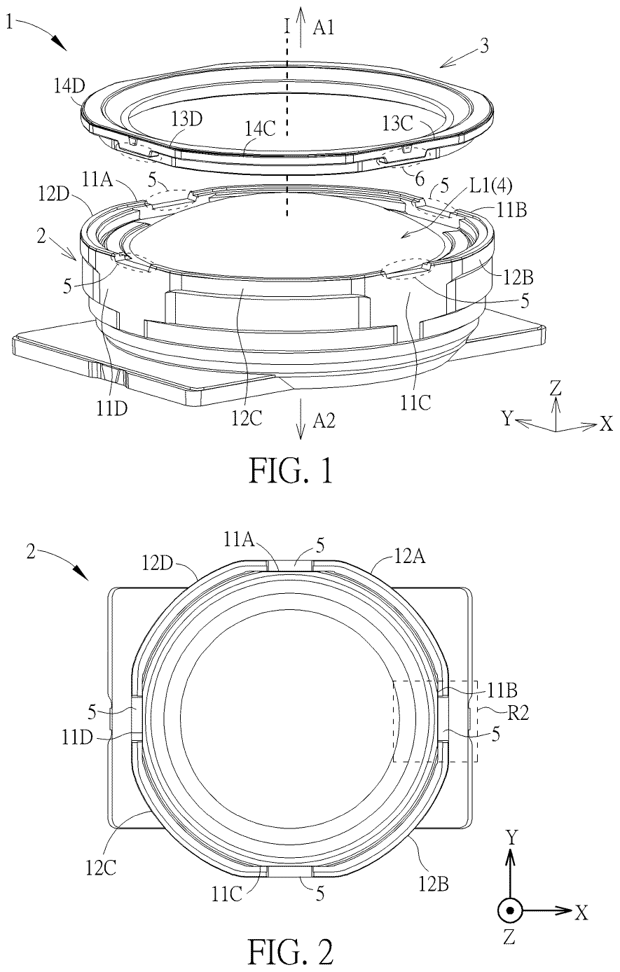

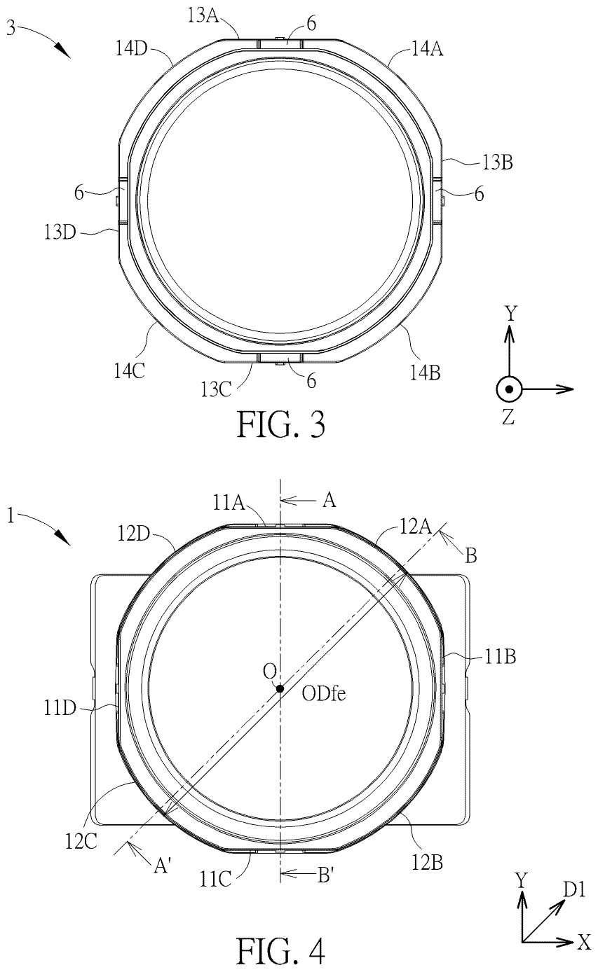

First, please refer to FIG. 1, FIG. 2, and FIG. 3. FIG. 1 illustrates an exploded view of the structure of the optical imaging lens of the invention, FIG. 2 illustrates a top view of the barrel of the optical imaging lens of the invention, and FIG. 3 illustrates a bottom view of the fixing ring of the optical imaging lens of the invention. As shown in FIG. 1, an optical imaging lens 1 of the invention includes a barrel 2, a fixing ring 3, and a lens group 4 located inside the barrel 2. The material of the barrel 2 may include plastic or metal, but not limited thereto, and the function of the barrel 2 is to accommodate, support, and protect the lens group 4 located in the barrel 2. The function of the fixing ring 3 is to fix the lens group 4 inside the barrel 2, preventing the lens group 4 from detaching or shifting from the barrel 2.

In FIG. 1, an optical axis I, a first side A1, and a second side A2 are defined. The optical axis I is the optical axis of the entire optical imaging lens 1, so the optical axis of each lens in the lens group 4 and the optical axis I of the optical imaging lens 1 are the same. The first side A1, for example, is the object side of the optical imaging lens 1, and the second side A2, for example, is the image side of the optical imaging lens 1. When rays (not shown) emitted by an object to be photographed (not shown) located on the first side A1 enters the optical imaging lens 1 of the invention, it will sequentially pass through each lens of the lens group 4 along the optical axis I and focus on an imaging plane (not shown) on the second side A2 to form a clear image.

In addition, the aforementioned lens group 4 may include a plurality of lens elements arranged along the direction of the optical axis I, wherein the number, size, surface shape, and other parameters of the lens elements included in the lens group 4 can be adjusted according to different product requirements, and the invention does not limit this. In other words, the optical imaging lens 1 may include the lens group 4 with various different conditions, and if the rays passing through the optical imaging lens 1 can form a clear image on the imaging plane, the optical imaging lens 1 falls within the scope covered by the invention.

In FIG. 1, the lens group 4 is arranged in the barrel 2, and a lens element closest to the first side A1 among the lens group 4 is defined as a first lens element L1. Although only the first lens element L1 is visible in FIG. 1, it can be understood that the lens group 4 also includes other lens elements located in the barrel 2 and arranged along the optical axis I. It is worth noting that, in FIG. 1, the first lens element L1 is the lens element closest to the fixing ring 3 among all the lens elements of the lens group 4, and it is also the first lens that rays emitted from the first side A1 (e.g., object side) enters.

As described in the background section, in order to increase the telephoto magnification of the optical imaging lens 1, it is necessary to increase the entrance pupil diameter of the optical imaging lens. However, since the entrance pupil diameter is proportional to the area of the first lens element L1 of the optical imaging lens 1 (in the XY plane), that is to say, it is necessary to manufacture the first lens element L1 with a larger area to increase the entrance pupil diameter. However, this will also increase the volume of the barrel 2, which is not conducive to the miniaturization of optical products.

Therefore, in order to increase the telephoto magnification of the optical imaging lens 1 while not excessively increasing the volume of the optical imaging lens 1, the invention improves the structure of the barrel 2 and the fixing ring 3 of the optical imaging lens 1. More specifically, please refer to FIG. 1, FIG. 2, and FIG. 3, in the conventional technology, from the top view direction (XY plane), the outer contour shape of a lens element is usually circular, and to match the shape of the lens element, the barrel 2 used to accommodate the lens element also has a circular outer contour, that is to say, the barrel 2 is cylindrical and has arc-shaped side walls. However, in the invention, the outer contours of the barrel 2 and the fixing ring 3 are not circular but are shapes composed of four straight lines and four arc lines alternately. Taking the barrel 2 as an example, the outer side wall of the barrel 2 includes four vertical wall parts 11A, 11B, 11C, 11D and four circular arc wall parts 12A, 12B, 12C, 12D, wherein the four vertical wall parts 11A, 11B, 11C, 11D and the four circular arc wall parts 12A, 12B, 12C, 12D are spaced apart from each other and symmetrically arranged. That is to say, from the top view of FIG. 2, each vertical wall part presents a straight line, and each circular arc wall part presents an arc line. In a clockwise direction, the barrel 2 sequentially includes the vertical wall part 11A, the circular arc wall part 12A, the vertical wall part 11B, the circular arc wall part 12B, the vertical wall part 11C, the circular arc wall part 12C, the vertical wall part 11D, and the circular arc wall part 12D. Each vertical wall part is structurally symmetrical to another vertical wall part in the opposite direction, and each circular arc wall part is also structurally symmetrical to another circular arc wall part in the opposite direction. For example, the vertical wall part 11A and the vertical wall part 11C are symmetrical to each other, the circular arc wall part 12B and the circular arc wall part 12D are symmetrical to each other, and so on for the other parts.

From the perspective view shown in FIG. 1, the shape of the barrel 2 of the invention is similar to truncating a cylindrical barrel in four different orientations, so the outer diameter size of the barrel 2 can be reduced, and the total volume of the optical imaging lens 1 is reduced. For a more concise explanation, in the following paragraphs, the outer contour shape of the barrel 2 shown in FIG. 2 is defined as a “truncated circle,” that is, a shape alternately composed of four arc edges and four straight lines and symmetrically arranged.

Similarly, as shown in FIG. 3, the outer contour of the fixing ring 3 of the invention is also a truncated circle composed of four arc lines and four straight lines. That is to say, from the perspective view (FIG. 1), the fixing ring 3 also includes four vertical wall parts 13A, 13B, 13C, 13D and four circular arc wall parts 14A, 14B, 14C, 14D, wherein the four vertical wall parts 13A, 13B, 13C, 13D and the four circular arc wall parts 14A, 14B, 14C, 14D are spaced apart from each other and symmetrically arranged. For example, in a clockwise direction, the fixing ring 3 sequentially includes the vertical wall part 13A, the circular arc wall part 14A, the vertical wall part 13B, the circular arc wall part 14B, the vertical wall part 13C, the circular arc wall part 14C, the vertical wall part 13D, and the circular arc wall part 14D. It is also worth noting that FIG. 3 is a bottom view of the fixing ring 3, corresponding to the angle from the −Z direction toward the +Z direction in FIG. 1, so the fixing ring 3 in FIG. 3 includes a plurality of protruding structures 6, and the characteristics of the protruding structures 6 will be described in subsequent paragraphs.

It is worth noting that the invention changes the structure of the barrel 2 and the fixing ring 3, changing the outer contour from a circle to a truncated circle, which can reduce the outer contour size of the barrel 2 and the fixing ring 3 and reduce the total volume of the optical imaging lens 1. However, because the outer contours of the barrel 2 and the fixing ring 3 of the invention become truncated circles (as shown in FIG. 2 and FIG. 3), compared to the conventional technology (where the outer contours of the barrel 2 and the fixing ring 3 are both circular), the rotational symmetry of the outer contours of the barrel 2 and the fixing ring 3 will be reduced. The “rotational symmetry” mentioned here refers to the property of a shape remaining the same as the original pattern after rotation. For example, a circle remains the same as the original pattern no matter how many degrees it is rotated, so a circle has infinite-order rotational symmetry, while a truncated circle is the same as the original pattern only when rotated by 90 degrees, 180 degrees, 270 degrees, and 360 degrees, so a truncated circle has fourth-order rotational symmetry.

When the rotational symmetry of the pattern decreases, the influence of angular deviation between the barrel 2 and the fixing ring 3 increases, and the alignment requirement between the barrel 2 and the fixing ring 3 also increases accordingly. In other words, if an angular deviation occurs when assembling the fixing ring 3 with the barrel 2, it may lead to the possibility that the fixing ring 3 and the barrel 2 cannot be fully assembled, and it may even affect the imaging quality of the optical imaging lens 1.

Therefore, to solve these issues of possible rotational deviation between the barrel 2 and the fixing ring 3, the barrel 2 of the invention is provided with four groove structures 5, wherein each groove structure 5 is respectively arranged on the vertical wall parts 11A, 11B, 11C, 11D of the barrel 2 and is arranged toward the first side A1, that is, toward the direction of the fixing ring 3. In addition, the fixing ring 3 of the invention is provided with four protruding structures 6, wherein each protruding structure 6 is respectively arranged on the vertical wall parts 13A, 13B, 13C, 13D of the fixing ring 3 and is arranged toward the second side A2, that is, toward the direction of the barrel 2. In the invention, the four groove structures 5 of the barrel 2 can align with and fit into the four protruding structures 6 of the fixing ring 3, that is, the shape of the protruding structure 6 can correspond to the shape of the groove structure 5, and from the optical axis direction (Z direction), the protruding structure 6 can align with the corresponding groove structure 5. Therefore, by aligning and fitting the groove structures 5 with the protruding structures 6, the barrel 2 and the fixing ring 3 can be fully assembled without rotational deviation, avoiding the impact on optical imaging quality due to incomplete assembly of the barrel 2 and the fixing ring 3.

As described above, the concept of the invention is: increasing the area of the first lens element L1 in the XY plane to increase the telephoto magnification of the optical imaging lens 1, and reducing the outer contours of the barrel 2 and the fixing ring 3 to avoid excessive volume increase of the optical imaging lens 1, and further providing the groove structures 5 on the barrel 2 and the protruding structures 6 on the fixing ring 3 respectively, to prevent rotational deviation problems caused by the change in the outer contour shape of the barrel 2 and the fixing ring 3. Therefore, the invention can produce an optical imaging lens with high telephoto magnification, small volume, and good imaging quality.

In the following paragraphs, the detailed structure of the optical imaging lens 1 of the invention will be described. It can be understood that, although the following paragraphs may focus on describing the characteristics of a single element, such as describing the characteristics of one groove structure 5, these characteristics can cover all identical elements included in the optical imaging lens 1, that is, all four groove structures 5 in total. The same rule applies to other elements.

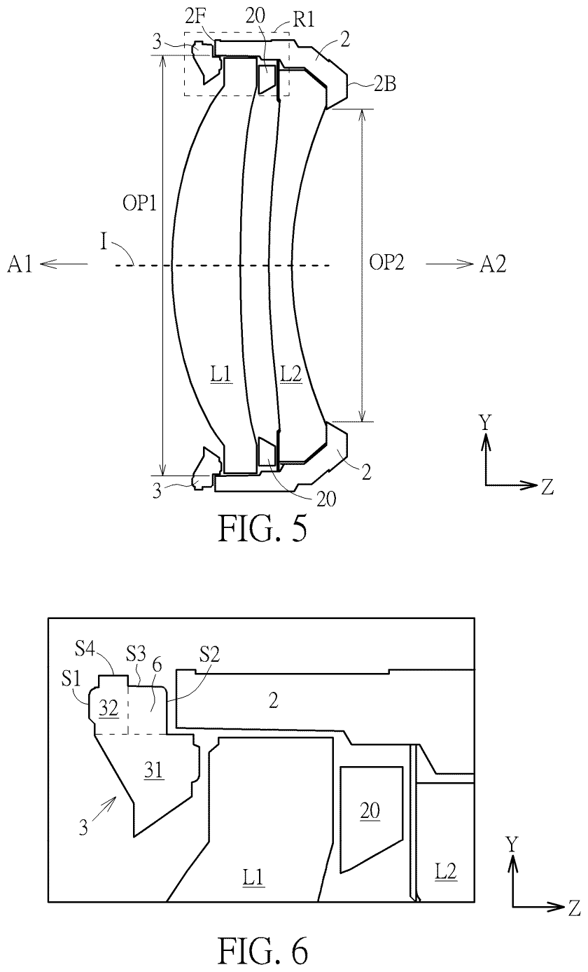

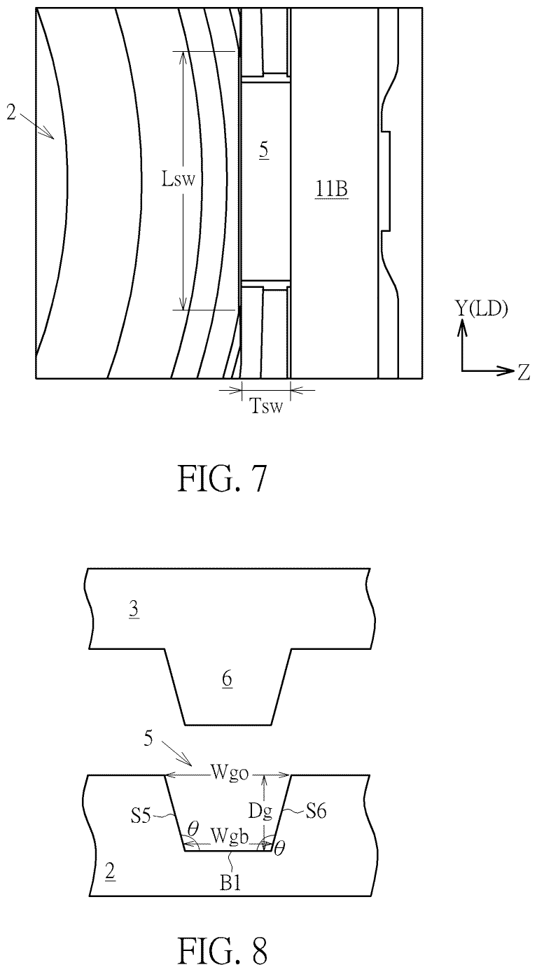

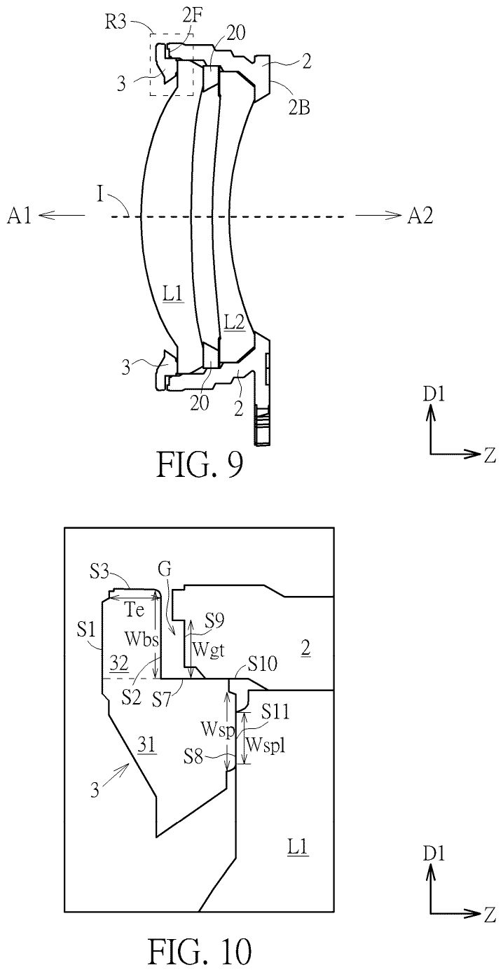

Please refer to FIG. 4, FIG. 5, FIG. 6, FIG. 7, FIG. 8, FIG. 9, and FIG. 10. FIG. 4 illustrates a top view of the optical imaging lens of the invention, that is, a top view structure after the barrel 2 and the fixing ring 3 of FIG. 1 are assembled together. FIG. 5 illustrates a sectional view taken along the section line A-A′ shown in FIG. 4, FIG. 6 illustrates a partially enlarged schematic view of the region R1 in FIG. 5, FIG. 7 illustrates an enlarged schematic view of the region R2 in FIG. 2, FIG. 8 illustrates a schematic sectional view of the groove structure of the barrel and the protruding structure of the fixing ring, FIG. 9 illustrates a sectional view taken along the section line B-B′ shown in FIG. 4, and FIG. 10 illustrates a partially enlarged schematic view of the region R3 in FIG. 9.

As shown in FIG. 4 to FIG. 10, the section line A-A′ in FIG. 4 is parallel to the Y-axis direction, and the section line A-A′ passes through the groove structure 5 of the barrel 2 and the protruding structure 6 on the fixing ring 3, so in the sectional views of FIG. 5 to FIG. 6, the barrel 2 includes the groove structure 5, and the fixing ring 3 includes the protruding structure 6. On the other hand, the section line B-B′ is parallel to the D1 direction, wherein the D1 direction is between the X-axis direction and the Y-axis direction in the XY plane, and although the section line B-B′ also passes through the barrel 2 and the fixing ring 3, it does not pass through the positions of the groove structure 5 and the protruding structure 6, so in the sectional views of FIG. 9 to FIG. 10, the barrel 2 does not include the groove structure 5, and the fixing ring 3 does not include the protruding structure 6.

As shown in FIG. 5, the barrel 2 includes a first lens element L1 and a second lens element L2 arranged along the optical axis I. As mentioned above, the invention does not limit the number of lens elements included in the optical imaging lens 1, so in other embodiments, the number, surface shape, size, and other parameters of the lens elements of the optical imaging lens 1 can be adjusted as needed, all falling within the scope covered by the invention. In addition, a spacer 20 is included between the first lens element L1 and the second lens element L2 in FIG. 5, and the function of the spacer 20 is to fix the lens elements in the barrel 2, maintain the spacing between the lens elements, and protect the periphery of the lens elements. It can be understood that if the optical imaging lens 1 includes more lens elements, the number of the spacers 20 may also increase accordingly, that is, a spacer 20 may be arranged between every two adjacent lens elements, and such variations also fall within the scope covered by the invention.

The “radial direction” described in the invention refers to a direction diverging outward from the position of the optical axis I and perpendicular to the optical axis I. From a perspective view, the radial direction includes an infinite number of directions, but from the sectional view of FIG. 5, the optical axis I extends along the Z direction, and the radial direction is a direction perpendicular to the Z-axis, that is, the radial direction is parallel to the Y-axis. From the sectional view of FIG. 9, the optical axis I extends along the Z direction, and the radial direction is a direction perpendicular to the Z-axis, that is, the radial direction is parallel to the D1 direction.

In FIG. 4, ODfe is defined as a maximum outer diameter of the circular arc wall parts of the barrel 2 in the radial direction. For example, as shown in FIG. 4, ODfe is a maximum distance (i.e., the diameter passing through the center point O of the barrel) from the outer side wall of the circular arc wall part 12A to the outer side wall of the circular arc wall part 12C along the D1 direction.

In FIG. 5, a front end 2F and a rear end 2B of the barrel 2 are defined. The front end 2F faces the first side A1, and the rear end 2B faces the second side A2. The front end 2F has a barrel first-side opening OP1, and the rear end 2B has a barrel second-side opening OP2, wherein the barrel first-side opening OP1 and the barrel second-side opening OP2 refer to the openings of the barrel 2 facing the first side A1 and the second side A2, respectively. In the invention, to maximize the entrance pupil diameter, the width of the barrel first-side opening OP1 in the radial direction is designed to be larger than the width of the barrel second-side opening OP2 in the radial direction to accommodate the first lens element L1 with a larger area, that is, a maximum inner diameter of the barrel first-side opening OP1 is larger than a maximum inner diameter of the barrel second-side opening OP2.

As shown in FIG. 6, the fixing ring 3 is defined with a body 31 facing the optical axis I and an outer edge portion 32 close to the barrel 2, wherein the body 31 and the outer edge portion 32 are both parts of the fixing ring 3. It is worth noting that the body 31 is mainly used to fix the lens elements, while the outer edge portion 32 includes the protruding structure 6, and the outer edge portion 32 can be used to connect the fixing ring 3 with the barrel 2, for example, by the fitting method of the aforementioned protruding structure 6 or by adhesion with the barrel 2, all falling within the scope covered by the invention, but not limited thereto.

In FIG. 6, the outer edge portion 32 includes a first surface S1 facing the first side A1, a second surface S2 facing the second side A2, and an outer side surface S3 facing the radial direction, wherein the outer side surface S3 connects the first surface S1 and the second surface S2, and the outer side surface S3 corresponds to the aforementioned four vertical wall parts 13A, 13B, 13C, 13D (please also refer to FIG. 3). In addition, the protruding structure 6 is arranged on the second surface S2. From FIG. 6, the protruding structure 6 includes several side surfaces, one of which is the second surface S2 facing the barrel 2, and another is the outer side surface S3 facing outward in the radial direction, that is, the vertical wall parts 13A, 13B, 13C, 13D, in other words, the outer side surface S3 is a vertical flat side wall. In addition, a gate cutoff surface S4 is included on the outer side surface S3. The gate cutoff surface S4 mentioned here is a cutoff surface formed by injection molding to form the fixing ring 3. Preferably, each of the four vertical wall parts 13A, 13B, 13C, 13D includes a gate cutoff surface S4, so from the top view, the fixing ring 3 has a total of four gate cutoff surfaces S4, which is advantageous for improving the symmetry of the fixing ring 3.

FIG. 7 illustrates an enlarged schematic view of the region R2 in FIG. 2, showing the surrounding position of the groove structure 5 on the vertical wall part 11B. A long-side direction LD is defined in the XY plane, and the long-side direction LD mentioned here is parallel to the longer side of the groove structure 5, for example, in FIG. 7, the groove structure 5 on the vertical wall part 11B and the vertical wall part 11D is arranged toward the Y direction, so for these two groove structures 5, the long-side direction LD is the Y-axis direction. As shown in FIG. 7, Lsw is defined here as the shortest length of the vertical wall part 11B in the long-side direction LD (i.e., the shortest length of the vertical wall part 11B in the Y-axis direction), and Tsw is a minimum thickness of the vertical wall part 11B in the radial direction. It can be understood that, although the long-side direction LD of the groove structure 5 shown in FIG. 7 is the Y-axis direction, for other groove structures 5, such as the groove structures 5 on the vertical wall part 11A and the vertical wall part 11C, since they are arranged along the X-axis direction, the long-side direction of these two groove structures 5 is the X-axis direction. In addition, whether the long-side direction LD is the X-axis direction or the Y-axis direction, it is perpendicular to the optical axis direction (Z direction).

FIG. 8 illustrates a schematic sectional view of the groove structure 5 of the barrel 2 and the protruding structure 6 of the fixing ring 3. From the sectional view, the groove structure 5 includes a bottom surface B1 and two inclined planes S5, S6. As shown in FIG. 8, θ is defined as the angle between the bottom surface B1 and the inclined plane S5 or the inclined plane S6, Dg is defined as the depth of the groove structure 5 (the depth in the Z-axis direction), Wgb is defined as the width of the bottom surface B1 of the groove structure 5, and Wgo is defined as the width of the opening of the groove structure 5 (i.e., the width at the top end of the groove structure 5). In addition, the aforementioned Wgb and Wgo refer to the width in the X-axis direction or the Y-axis direction, depending on whether the groove structure 5 is arranged toward the X-axis direction or the Y-axis direction.

FIG. 9 illustrates a sectional view taken along the section line B-B′ shown in FIG. 4, and FIG. 10 illustrates a partially enlarged schematic view of the region R3 in FIG. 9. Most elements in FIG. 9 and FIG. 10 are the same as those in FIG. 5 and FIG. 6, so the same elements are denoted with the same reference numerals. However, the main difference between FIG. 9 or FIG. 10 and the aforementioned FIG. 5 or FIG. 6 is that, since the section line B-B′ does not pass through the groove structure 5 and the protruding structure 6, the groove structure 5 and the protruding structure 6 are not shown in FIG. 9 or FIG. 10. In other words, the groove structure 5 and the protruding structure 6 of the invention are only located on the vertical wall parts and not on the circular arc wall parts.

As shown in FIG. 10, the fixing ring 3 also has a body 31 facing the optical axis I and an outer edge portion 32 facing outward in the radial direction, and the outer edge portion 32 includes a first surface S1 facing the first side A1, a second surface S2 facing the second side A2, and an outer side surface S3 facing the radial direction, wherein the outer side surface S3 connects the first surface S1 and the second surface S2, and the outer side surface S3 corresponds to the aforementioned four circular arc wall parts 14A, 14B, 14C, 14D (please also refer to FIG. 3). In addition, the sectional structure of the fixing ring 3 and the barrel 2 in FIG. 10 is also different from that shown in FIG. 6. More specifically, the body 31 of the fixing ring 3 in FIG. 10 includes a bearing side surface S7 parallel to the optical axis direction (Z-axis direction) and a bearing plane S8 parallel to the radial direction, wherein the bearing side surface S7 connects the second surface S2 and the bearing plane S8. In addition, the barrel 2 also includes a plane S9 facing the first side A1 and parallel to the radial direction, and a side surface S10 parallel to the optical axis direction (Z-axis direction). The first lens element L1 includes an assembly plane S11 parallel to the radial direction.

Wherein, the second surface S2 of the fixing ring 3 can be adhered to the plane S9 of the barrel 2 by a material such as adhesive, so the second surface S2 here can also be regarded as an adhesive surface. Alternatively, a glue storage groove G is left between the fixing ring 3 and the barrel 2, and the glue storage groove G, for example, is a gap between the second surface S2 of the fixing ring 3 and the plane S9 of the barrel 2. In actual assembly, adhesive can be first applied to the plane S9 of the barrel 2, and then the fixing ring 3 can be adhered to the barrel 2. Excess adhesive will extend along the glue storage groove G. In addition, from the top view, the glue storage groove G is located at the circular arc wall parts of the barrel 2 and the fixing ring 3, so the glue storage groove G also presents an arc shape.

When assembling the fixing ring 3 to the barrel 2, the bearing side surface S7 of the fixing ring 3 may contact the side surface S10 of the barrel 2 to increase the friction between them and enhance the fixing effect. As for the bearing plane S8 of the fixing ring 3, it contacts the assembly plane S11 of the first lens element L1, thereby fixing the first lens element L1 within the barrel 2 and preventing it from sliding.

As shown in FIG. 10, Wbs is defined as a maximum width of the second surface S2 (adhesive surface) in the radial direction D1, Wgt is defined as a maximum width of the glue storage groove G in the radial direction D1, Te is defined as a minimum thickness of the outer edge portion 32 in the optical axis direction (Z-axis direction), Wsp is defined as a maximum width of the bearing plane S8 in the radial direction D1, and Wsp1 is defined as a maximum width of the bearing plane S8 contacting the first lens element L1 in the radial direction D1.

The above paragraphs have introduced the detailed structure and functions of each element of the optical imaging lens 1 of the invention. In the following paragraphs, the dimensions of some elements will be restricted, please refer to the above specification paragraphs and drawings. When the conditions described below are satisfied, it helps to bring advantages such as improved structural strength, increased alignment accuracy, and enhanced manufacturing yield, as detailed in the following paragraphs.
1. The invention provides an optical imaging lens 1, from a first side A1 to a second side A2 along an optical axis I, sequentially including a fixing ring 3, a barrel 2, and a plurality of lens elements (lens group 4) arranged in the barrel 2. Wherein, the barrel 2 includes a front end 2F close to the first side A1 and a rear end 2B close to the second side A2, the front end 2F includes a barrel first-side opening OP1, the rear end 2B includes a barrel second-side opening OP2, a maximum inner diameter of the barrel first-side opening OP1 is larger than a maximum inner diameter of the barrel second-side opening OP2, the front end 2F of the barrel 2 includes four vertical wall parts (11A, 11B, 11C, 11D) and four circular arc wall parts (12A, 12B, 12C, 12D), the circular arc wall parts and the vertical wall parts are spaced apart from each other and symmetrically arranged. Each of the vertical wall parts (11A, 11B, 11C, 11D) includes a groove structure 5 along the optical axis direction, the groove structure 5 includes a bottom surface B1 and two inclined planes S5, S6, wherein the conditions of 100 degrees≤θ≤130 degrees, 0.3 mm≤Tsw≤0.6 mm, and 1.0≤Tsw/Dg≤2.0 are satisfied, wherein θ is an angle between the bottom surface B1 and the inclined planes (S5 or S6), Tsw is a minimum thickness of the vertical wall part in a radial direction, Dg is the depth of the groove structure 5 in the optical axis direction. The fixing ring 3 includes four protruding structures 6 in the optical axis direction, and the protruding structures 6 of the fixing ring 3 can complement the groove structures 5 of the barrel 2 to form an alignment structure. In the optical imaging lens 1 of the invention, the circular arc wall parts and the vertical wall parts being spaced apart and symmetrically arranged is advantageous for reducing the area of the barrel 2 in the two perpendicular directions of the XY plane. Each of the four vertical wall parts includes a groove structure 5 in the optical axis direction, the fixing ring 3 includes four protruding structures 6 in the optical axis direction, and the protruding structures 6 can complement the groove structures 5 to form an alignment structure, which is advantageous for the fixing ring 3 to form an alignment structure with the barrel 2 within the limited area of the XY plane. According to the inventor's experimental results, when the assembly thrust is 6 kilograms, the angular deviation of the fixing ring 3 can be controlled within 3°. The above features are advantageous for avoiding misalignment and interference between the fixing ring 3 and the plane of the barrel first-side opening OP1 during assembly alignment, that is, avoiding gaps between the fixing ring 3 and the barrel 2, which cause an increase in the thickness of the fixing ring 3 and the barrel 2 in the optical axis direction. When the condition of 100 degrees≤θ≤130 degrees is satisfied, it is advantageous for the bottom surface and the inclined planes of the groove structure 5 to form a suitable angle; if this angle is too small, the groove structure 5 is not easily formed and the yield is low, while if this angle is too large, it will lead to poor fitting effect, and the misalignment angle will increase. When the conditions of 0.3 mm≤Tsw≤0.6 mm and 1.0≤Tsw/Dg≤2.0 are further satisfied, it is advantageous for matching the angle of the bottom surface and the inclined planes of the groove structure 5, avoiding the thickness of the vertical wall parts being too thin, which leads to dimensional instability during molding shrinkage, and forming the groove structure 5 and the protruding structure 6 with sufficient strength to form an alignment structure, with a preferred restriction of 105 degrees≤θ≤125 degrees.
2. In some embodiments of the invention, wherein the optical imaging lens 1 satisfies the following condition: 1.7≤Lsw/Wgb≤2.4, Wgb is the width of the bottom surface B1 of the groove structure 5, Lsw is the shortest length of the vertical wall part (11A, 11B, 11C, 11D) in a long-side direction LD, wherein the long-side direction LD is perpendicular to the optical axis direction (Z-axis direction), and the long-side direction LD is parallel to a long side of the vertical wall part. When the above condition is satisfied, it is advantageous for designing a suitable ratio of the length and width of the groove structure 5 in a plane perpendicular to the optical axis (XY plane), increasing the accuracy of computer vision interpretation.
3. In some embodiments of the invention, wherein the optical imaging lens 1 satisfies the following condition: 6.0≤ODfe/Wgb≤9.5, ODfe is a maximum outer diameter of the circular arc wall parts (12A, 12B, 12C, 12D) in the radial direction, Wgb is the width of the bottom surface B1 of the groove structure 5. When the above condition is satisfied, it is advantageous for designing an alignment structure under the limited area of the XY plane of the barrel 2 and the fixing ring 3 without affecting the travel of imaging rays.
4. In some embodiments of the invention, wherein the optical imaging lens 1 satisfies the following condition: 1.05≤Wgo/Wgb≤2.00, Wgb is the width of the bottom surface of the groove structure, Wgo is the width of the opening of the groove structure. When the above condition is satisfied, it is advantageous for designing a suitable ratio to increase the alignment accuracy of the protruding structure 6 and the groove structure 5.
5. In some embodiments of the invention, wherein the optical imaging lens 1 satisfies the following condition: 3.3≤Wgb/Dg≤10.0, wherein Wgb is the width of the bottom surface of the groove structure. When the above condition is satisfied, it is advantageous for designing a suitable depth of the groove structure 5, avoiding damage to the protruding structure 6 during alignment assembly.
6. In some embodiments of the invention, wherein among the plurality of lens elements, a maximum outer diameter of a lens element closest to the first side A1 (i.e., the first lens element L1) is larger than a maximum outer diameter of a lens element closest to the second side A2. When the above condition is satisfied, it is advantageous for assembling the fixing ring 3 and the lens group in the barrel 2 with a limited radial space.
7. In some embodiments of the invention, wherein the fixing ring 3 includes an outer edge portion 32 and a body 31, the outer edge portion 32 includes a first surface S1 facing the first side A1, a second surface S2 facing the second side A2, an outer side surface S3 facing the radial direction, the outer side surface S3 connects the first surface S1 and the second surface S2, the outer side surface S3 has four outer vertical planes (i.e., vertical wall parts 13A, 13B, 13C, 13D), the protruding structure 6 is arranged on the second surface S2, one side surface of the protruding structure 6 is the outer vertical plane (i.e., vertical wall parts 13A, 13B, 13C, 13D), and the outer vertical planes each include a gate cutoff surface S4. When the above condition is satisfied, it is advantageous for the fixing ring 3 not to require an additional plane to arrange the gate cutoff surface S4 thereon, and it is advantageous for the outer side surface S3 to reduce the area in two perpendicular directions in the XY plane, and by the gate cutoff surfaces S4 in four different directions, it increases the yield of forming the protruding structure 6 of the fixing ring 3 by an injection molding process.
8. In some embodiments of the invention, please refer to FIG. 10, wherein the second surface S2 includes an annular adhesive surface, and a glue storage groove G is included between the fixing ring 3 and the barrel 2, the optical imaging lens 1 satisfies the following condition: 1.5≥Wbs/Wgt≥1.2, wherein Wbs is a maximum width of the adhesive surface in the radial direction, Wgt is a maximum width of the glue storage groove G in the radial direction. When the above condition is satisfied, it is advantageous for the glue storage groove G of the barrel 2 to adhere to the adhesive surface S2 of the fixing ring 3, which is advantageous for increasing the structural strength after adhesion of the fixing ring 3 and the barrel 2.
9. In some embodiments of the invention, please refer to FIG. 10, wherein the optical imaging lens 1 satisfies the following condition: Te≥0.25 mm, wherein Te is a minimum thickness of the outer edge portion in the optical axis direction. When the above condition is satisfied, it is advantageous for matching the design of the gate cutoff surface S4, increasing the yield and structural strength of the outer edge portion 32 in injection molding, with a preferred restriction of 0.50 mm≥Te≥0.25 mm.
10. In some embodiments of the invention, please refer to FIG. 10, wherein the body 31 includes a bearing plane S8 facing the second side A2, and a bearing side surface S7 parallel to the optical axis direction, wherein the bearing side surface S7 connects the second surface S2 and the bearing plane S8, and the optical imaging lens satisfies the following condition: 2.3≥Wsp/Wsp1≥1.3, wherein Wsp is a maximum width of the bearing plane S8 in the radial direction, Wsp1 is a maximum width of the bearing plane S8 contacting the first lens element L1 in the radial direction. When the above condition is satisfied, it is advantageous for matching the alignment structure, reducing alignment errors while maintaining the bearing strength of the lens.

The invention further proposes three embodiments, as shown in Table 1 below, wherein Embodiment 1, Embodiment 2, and Embodiment 3 represent the parameter values of different embodiments, and the definitions of each parameter are as described above. The parameters of the following Embodiments 1-3 conform to the above condition ranges, so each embodiment can achieve the aforementioned advantages such as increasing structural strength and improving alignment accuracy. It is worth noting that, although Table 1 below lists three embodiments of the invention, the embodiments shown are only a few examples of the invention, and the invention is not limited thereto.

TABLE 1

| | Embodiment 1 | Embodiment 2 | Embodiment 3 |
|---|---|---|---|
| Tsw | 0.300 | 0.300 | 0.600 |
| Dg | 0.150 | 0.300 | 0.300 |
| θ | 105.000 | 110.000 | 125.000 |
| Lsw | 1.700 | 2.600 | 3.500 |
| Wgb | 1.000 | 1.200 | 1.500 |
| ODfe | 9.230 | 10.000 | 9.230 |
| Wgo | 1.080 | 1.418 | 1.920 |
| Wbs | 0.300 | 0.350 | 0.500 |
| Wgt | 0.200 | 0.250 | 0.400 |
| Te | 0.250 | 0.300 | 0.500 |
| Wsp | 0.250 | 0.300 | 0.400 |
| Wspl | 0.180 | 0.180 | 0.180 |

In summary, the invention is characterized in that, in order to increase the telephoto magnification of the optical imaging lens, it is necessary to increase the entrance pupil diameter of the optical imaging lens. However, since the entrance pupil diameter is proportional to the area of the first lens of the optical imaging lens, it will lead to an increase in the inner diameter and outer diameter dimensions of the lens and cause an increase in the volume of the barrel, which is not conducive to the miniaturization of optical products. Therefore, the invention improves the structure of the optical imaging lens by truncating the outer side surface of the barrel in four different directions, that is, changing the original cylindrical side wall of the barrel into a shape with symmetrically and alternately arranged circular arc wall parts and vertical wall parts. In this way, the total volume of the barrel can be reduced. However, after the above structural change to the barrel, the alignment accuracy requirement between the barrel and the fixing ring also increases, so the invention provides a plurality of groove structures on the barrel and a plurality of corresponding protruding structures on the fixing ring, the groove structures on the barrel and the protruding structures on the fixing ring complementing each other to form an alignment structure. Therefore, the alignment degree between the barrel and the fixing ring can be accurately improved. In addition, the invention also restricts and defines the dimensions of various components on the barrel and the fixing ring. Under the restriction conditions of the invention, an optical imaging lens with high alignment accuracy, high structural strength, and good imaging quality can be produced.

The above description is only the preferred embodiments of the invention, and all equivalent changes and modifications made in accordance with the claims of the invention should fall within the scope covered by the invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical imaging lens, from a first side to a second side along an optical axis, sequentially comprising:
a fixing ring, a barrel, and a plurality of lens elements arranged in the barrel;
wherein the barrel includes a front end close to the first side and a rear end close to the second side;
the front end includes a barrel first-side opening, the rear end includes a barrel second-side opening, a maximum inner diameter of the barrel first-side opening is larger than a maximum inner diameter of the barrel second-side opening;
the front end of the barrel includes four vertical wall parts and four circular arc wall parts, the circular arc wall parts and the vertical wall parts are spaced apart from each other and symmetrically arranged;
each of the vertical wall parts includes a groove structure along an optical axis direction, the groove structure includes a bottom surface and two inclined planes, wherein the conditions of 100 degrees≤θ≤130 degrees, 0.3 mm≤Tsw≤0.6 mm, and 1.0≤Tsw/Dg≤2.0 are satisfied, wherein θ is an angle between the bottom surface and the inclined planes, Tsw is a minimum thickness of the vertical wall part in a radial direction, Dg is the depth of the groove structure in the optical axis direction;
the fixing ring includes four protruding structures in the optical axis direction, the protruding structures of the fixing ring can complement the groove structures of the barrel to form an alignment structure.

2. The optical imaging lens according to claim 1, wherein the optical imaging lens satisfies the following condition: 1.7≤Lsw/Wgb≤2.4, wherein Wgb is the width of the bottom surface of the groove structure, Lsw is the shortest length of the vertical wall part in a long-side direction, wherein the long-side direction is perpendicular to the optical axis direction, and the long-side direction is parallel to a long side of the vertical wall part.

3. The optical imaging lens according to claim 1, wherein the optical imaging lens satisfies the following condition: 6.0≤ODfe/Wgb≤9.5, wherein ODfe is a maximum outer diameter of the circular arc wall parts in the radial direction, Wgb is the width of the bottom surface of the groove structure.

4. The optical imaging lens according to claim 1, wherein the optical imaging lens satisfies the following condition: 1.05≤Wgo/Wgb≤2.00, wherein Wgb is the width of the bottom surface of the groove structure, Wgo is the width of the opening of the groove structure.

5. The optical imaging lens according to claim 1, wherein the optical imaging lens satisfies the following condition: 3.3≤Wgb/Dg≤10.0, wherein Wgb is the width of the bottom surface of the groove structure.

6. The optical imaging lens according to claim 1, wherein among the plurality of lens elements, a maximum outer diameter of a lens element closest to the first side is larger than a maximum outer diameter of a lens element closest to the second side.

7. The optical imaging lens according to claim 1, wherein the fixing ring includes an outer edge portion and a body, the outer edge portion includes a first surface facing the first side, a second surface facing the second side, an outer side surface facing the radial direction, the outer side surface connects the first surface and the second surface, the outer side surface has four outer vertical planes, the protruding structure is arranged on the second surface, one side surface of the protruding structure is the outer vertical plane, and the outer vertical planes each include a gate cutoff surface.

8. The optical imaging lens according to claim 7, wherein the second surface includes an annular adhesive surface, and a glue storage groove is included between the fixing ring and the barrel, the optical imaging lens satisfies the following condition: 1.5≥Wbs/Wgt≥1.2, wherein Wbs is a maximum width of the adhesive surface in the radial direction, Wgt is a maximum width of the glue storage groove in the radial direction.

9. The optical imaging lens according to claim 7, wherein the optical imaging lens satisfies the following condition: Te≥0.25 mm, wherein Te is a minimum thickness of the outer edge portion in the optical axis direction.

10. The optical imaging lens according to claim 7, wherein the body includes a bearing plane facing the second side, and a bearing side surface parallel to the optical axis direction, wherein the bearing side surface connects the second surface and the bearing plane, and the optical imaging lens satisfies the following condition: 2.3≥Wsp/Wsp1≥1.3, wherein Wsp is a maximum width of the bearing plane in the radial direction, Wsp1 is a maximum width of the bearing plane contacting the lens in the radial direction.
